(19) United States
(12) Patent Application Publication
(10) Pub. No.: US 2012/0300382 A1
(43) Pub. Date: Nov. 29, 2012

(54) NOTEBOOK COMPUTER INCLUDING A DETACHABLE KEYBOARD

(75) Inventor: WEN-CHI HUANG, Tu-Cheng (TW)

(73) Assignee: HON HAI PRECISION INDUSTRY CO., LTD., Tu-Cheng (TW)

(21) Appl. No.: 13/195,030

(22) Filed: Aug. 1, 2011

(30) Foreign Application Priority Data
May 23, 2011 (TW) 100117891

(51) Int. Cl. G06F 1/16

(52) U.S. Cl. 361/679.17

(57) ABSTRACT

An exemplary notebook computer includes a first cover, a keyboard, and a second cover. Two resisting members protrudes from a sidewall of a receiving space defined in the first cover. The first cover deforms under finger pressure to allow the fitment and containment of a keyboard in the receiving space. The keyboard includes a main body and a flange extending around the peripheral of the main body. The second cover defines a pair of through holes aligned with the resisting members, and when for example finger pressure is applied to the base of the keyboard, the keyboard moves out the receiving space.

### BACKGROUND

1. Technical Field

The present disclosure relates to notebook computers and, particularly, to a notebook computer having a detachable keyboard.

2. Description of Related Art

A conventional notebook computer includes a keyboard integrated into a main body of the notebook computer. Depending on the size and location of the keyboard, the wrists of the user may rest on the base of the notebook computer or be suspended in midair. If the user is required to keep his/her hands suspended in midair for a long time, this is liable to cause muscle fatigue.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a notebook computer including a detachable keyboard in accordance with an exemplary embodiment.

FIG. 2 is an enlarged, top plan view of part of the notebook computer of FIG. 1, showing a corner of the detachable keyboard.

FIG. 3 is an enlarged view of part of the notebook computer of FIG. 1, but omitting the keyboard.

FIG. 4 is an enlarged view of part of the keyboard of FIG. 1.

FIG. 5 is a cutaway view corresponding to line V-V of FIG. 2.

### DETAILED DESCRIPTION

Embodiments of the present disclosure are now described in detail, with reference to the accompanying drawings.

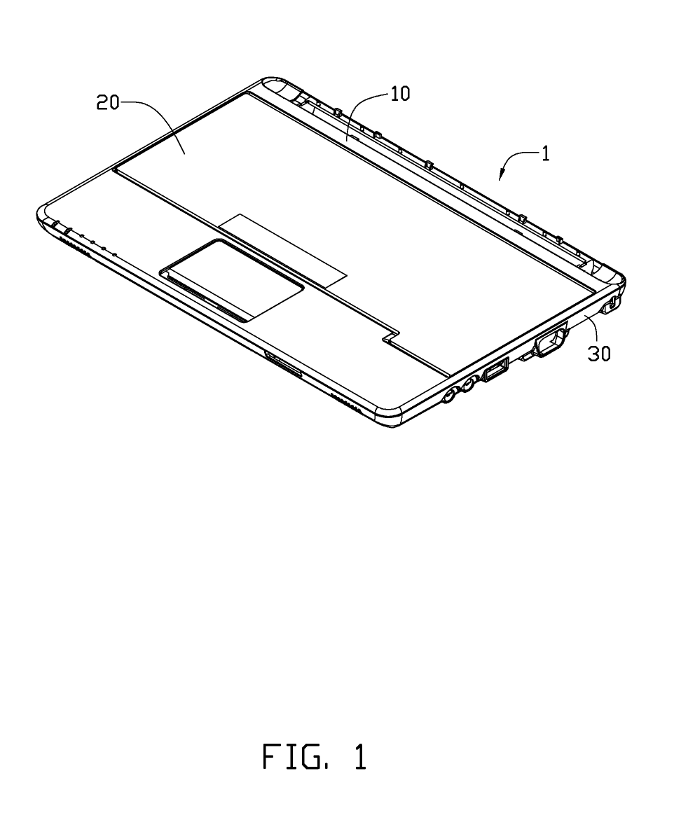

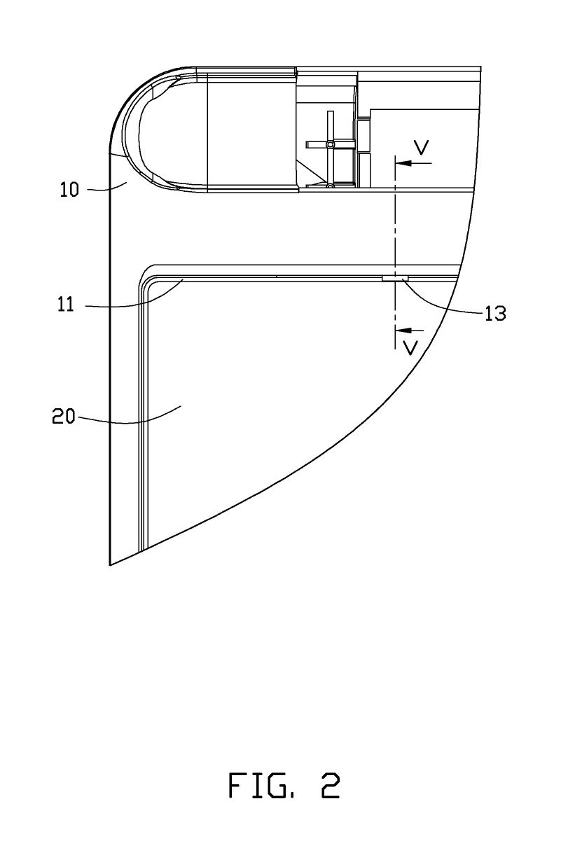

Referring to FIGS. 1-2, a notebook computer 1 includes a first cover 10, a keyboard 20, and a second cover 30. In the embodiment, the first cover 10 can be slightly elastically deformed when an external force is exerted thereon, to fit the first cover 10 to the second cover 30. The first cover 10 and the second cover 30 cooperatively form a case with a chamber (receiving room) to receive components of the notebook computer 1. The first cover 10 includes a receiving space 11 to receive the keyboard 20. In the embodiment, the size of the receiving space 11 is the same as that of the keyboard 20. A first wireless communication unit (not shown) and a first interface (not shown) are arranged within the receiving room defined by the first cover 10 and the second cover 30. The keyboard 20 includes a corresponding second wireless communication unit (not shown), a keyboard circuit (not shown) and a second interface (not shown). The keyboard 20 is capable of communicating with a processor of the notebook computer 1 through the wireless communication units. Alternatively, the first interface and the second interface can be connected by a cable.

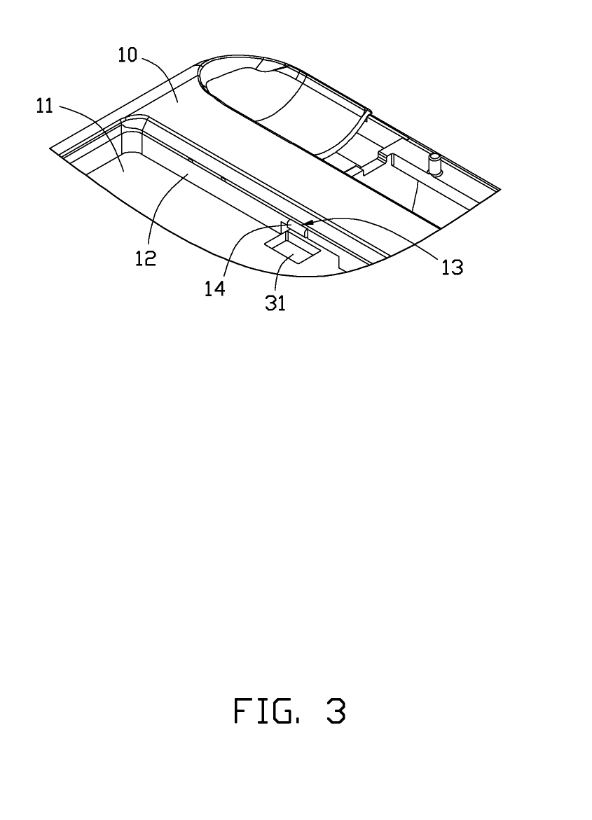

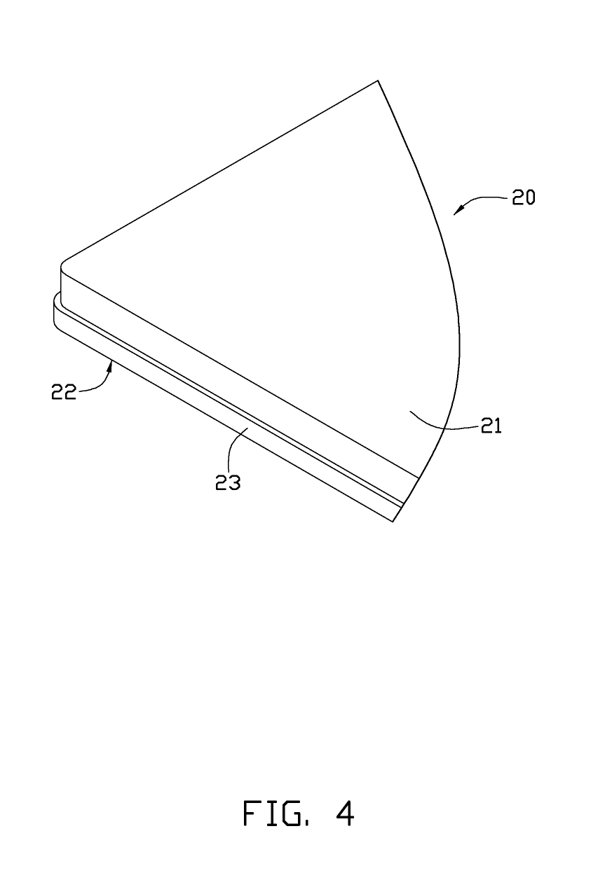

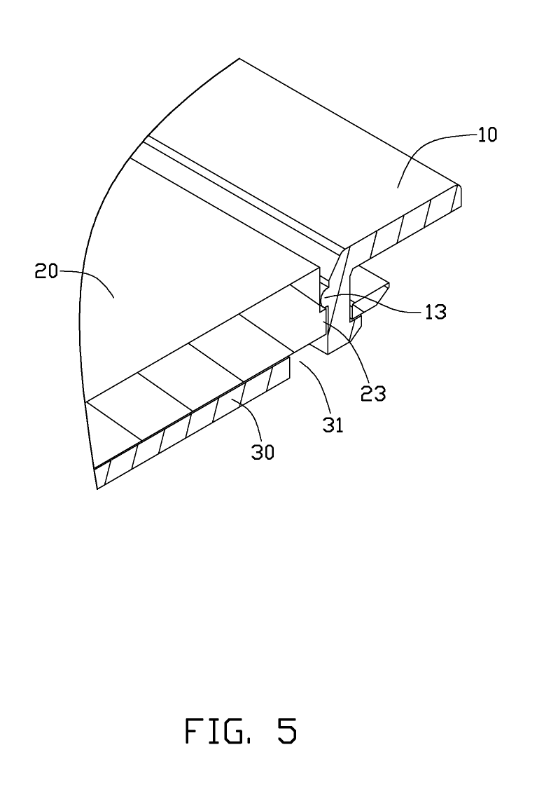

Referring also to FIGS. 3-5, the first cover 10 includes at least one resisting member 13. The at least one resisting member 13 protrudes from a sidewall 12 of the receiving space 11. In the embodiment, there are two resisting members 13, which are aligned with each other. Each resisting member 13 is perpendicular to the sidewall 12, and an outer surface 14 of each resisting member 13 is a convex curved surface. In the embodiment, each resisting member 13 is intended to function as a stop or at least a hindrance to the upward movement of the keyboard 20 below it.

The keyboard 20 includes a main body 21 and a supporting member 22. In the embodiment, the supporting member 22 is made of metal. The supporting member 22 is arranged below the main body 21 to support the main body 21 and to shield the main body 21 from electromagnetic interference (EMI). The size of the supporting member 22 is slightly greater than that of the main body 21. Thus, the supporting member 22 defines a flange 23 extending around a periphery thereof. In the embodiment, the flange 23 protrudes a short distance from the main body 21. When the keyboard 20 is received in the receiving space 11, the flange 23 is below the resisting members 13 and is constrained by the resisting members 13 so as to prevent inadvertent or accidental disengagement of the keyboard 20 from the receiving space 11.

The second cover 30 defines at least one through hole 31 corresponding to the at least one resisting member 13. Thus in the embodiment, there are two through holes 31. When the first cover 10 is attached to the second cover 30, each through hole 31 is aligned with one corresponding resisting member 13, to allow an object such as a thin rod or a fingertip to physically access the bottom of the keyboard 20.

When the keyboard 20 is pushed up by a thin rod (for example), the flange 23 of the supporting member 22 presses against the resisting member 13, which causes a slight deformation of the first cover 10 until the flange 23 of the supporting member 22 has moved out of the receiving space 11. The keyboard 20 is thus detached from the first cover 10 and the second cover 30, and can (for example) wirelessly communicate with the processor of the notebook computer 1.

To replace the keyboard 20 in the receiving space 11, the flange 23 must be rested on the resisting members 13, and the keyboard 20 then pressed down firmly. The flange 23 of the keyboard 20 rides over the resisting members 13, which causes a slight deformation of the first cover 10 until the keyboard 20 has been completely received in the receiving space 11.

Although the present disclosure has been specifically described on the basis of the exemplary embodiments thereof, the disclosure is not to be construed as being limited thereto. Various changes or modifications may be made to the embodiments without departing from the scope and spirit of the disclosure.

What is claimed is:

1. A notebook computer comprising:
a first cover capable of being elastically deformed when an external force is exerted thereon, the first cover defining a receiving space and comprising at least one resisting member, the at least one resisting member protruding from a sidewall of the receiving space;
a keyboard configured to be received in the receiving space, and comprising a main body and a flange extending around a periphery of the main body; and
a second cover defining at least one through hole below and aligned with the at least one resisting member, the first cover being attached to the second cover;
wherein when the keyboard is completely received in the receiving space, the flange of the keyboard is below the at least one resisting member and is constrained by the at least one resisting member to prevent inadvertent disengagement of the keyboard from the receiving space; and
when the keyboard is pushed by an object passing through the through hole, the flange of the keyboard presses against the at least one resisting member and causes the first cover to be deformed until the flange of the keyboard has moved out from the receiving space.

2. The notebook computer as described in claim 1, wherein the keyboard further comprises a supporting member, the size of the supporting member is greater than that of the main body, and a periphery of the supporting member forms the flange.

3. The notebook computer as described in claim 1, wherein an outer surface of the resisting member is a convex curved surface.

4. The notebook computer as described in claim 1, wherein the size of the receiving space is the same as that of the keyboard.

5. A notebook computer comprising:
an elastically deformable upper cover, the upper cover defining a top recess bounded on one side by a sidewall, the sidewall comprising a pair of clasps protruding therefrom into the recess;
a keyboard sized to be fittedly received in the recess, and comprising a main body and a flange at a periphery of the main body; and
a lower cover defining a pair of through holes below and aligned with the clasps, the lower cover being fixedly attached to the upper cover;
wherein when the keyboard is engaged in the recess, the flange of the keyboard is constrained by bottoms of the clasps to prevent inadvertent disengagement of the keyboard from the recess; and
when a bottom of the keyboard is pushed up by an object passing through one of the through holes, the flange of the keyboard urges the corresponding clasp, and the clasp drives the upper cover to elastically deform such that the flange of the keyboard rides up and over the clasps and the keyboard is disengaged from the recess.

6. The notebook computer as described in claim 1, wherein the keyboard further comprises a supporting member, the size of the supporting member is greater than that of the main body, and a periphery of the supporting member forms the flange.

7. The notebook computer as described in claim 1, wherein an outer surface of the clasp is a convex curved surface.

8. The notebook computer as described in claim 1, wherein the size of the recess is the same as that of the keyboard.
